(19) United States
(12) Patent Application Publication
(10) Pub. No.: US 2025/0135627 A1
(43) Pub. Date: May 1, 2025

(54) TOOL HOLDER RAIL AND TOOL HOLDER INCLUDING THE SAME

(71) Applicant: CHUN NIEN PLASTIC LTD., Taichung City (TW)

(72) Inventor: CHI-TSAI CHANG, Taichung City (TW)

(21) Appl. No.: 18/496,187

(22) Filed: Oct. 27, 2023

(51) Int. Cl. B25H 3/00

(52) U.S. Cl. CPC B25H 3/003

(57) ABSTRACT

A tool holder rail and a tool holder including the same are provided, wherein the tool holder rail includes: an elongate main body extending in a longitudinal direction and including two mounting sides extending in the longitudinal direction, the two mounting sides being inclined to each other with an included angle therebetween; and two rail slots disposed on the two mounting sides, respectively, each of the two rail slots including two flanges extending in the longitudinal direction and toward each other, each of the two rail slots being configured for slidable engagement of a tool seat.

### BACKGROUND OF THE INVENTION

### Field of the Invention

The present invention relates to a tool holder rail and a tool holder including the same.

### Description of the Prior Art

Tools are often used to drive members to be driven, such as screws, nuts or the like. Because the members to be driven are of various sizes (or of the metric and imperial systems), it is necessary to prepare tools corresponding to members to be driven of various sizes. It is understandable that a large number of tools need to be placed and stored according to their sizes; otherwise it will be troubled when in use or not in use. Therefore, some storing racks and storage devices are developed.

However, the conventional storing rack or storage device includes only single one rail for slidable engagement of a tool seat, and the only single one rail is parallel to the attachment side of the conventional storing rack or storage device. As such, it has a small capacity of storing for tools so that it requires more storing rack or storage device to store the tools.

The present invention is, therefore, arisen to obviate or at least mitigate the above-mentioned disadvantages.

### SUMMARY OF THE INVENTION

The main object of the present invention is to provide a tool holder rail and a tool holder including the same, which is capable of storing more tools and has a small volume.

To achieve the above and other objects, a tool holder rail is provided, wherein the tool holder rail includes: an elongate main body extending in a longitudinal direction and including two mounting sides extending in the longitudinal direction, the two mounting sides being inclined to each other with an included angle therebetween; and two rail slots disposed on the two mounting sides, respectively, each of the two rail slots including two flanges extending in the longitudinal direction and toward each other, each of the two rail slots being configured for slidable engagement of a tool seat.

To achieve the above and other objects, a tool holder is further provided, wherein the tool holder includes: the tool holder rail and a tool seat slidably engaged within one of the two rail slots.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a partial breakdown drawing of an exemplary embodiment of the present invention;

FIG. 4 is a cross-sectional view of an exemplary embodiment of the present invention; and

FIG. 5 is a partial enlarged cross-sectional view of an exemplary embodiment of the present invention.

### DETAILED DESCRIPTION OF THE PREFERRED EMBODIMENTS

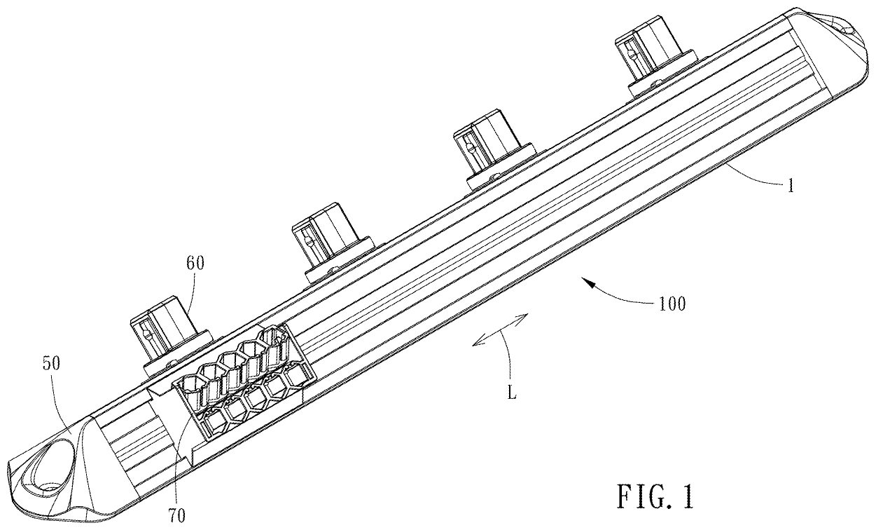

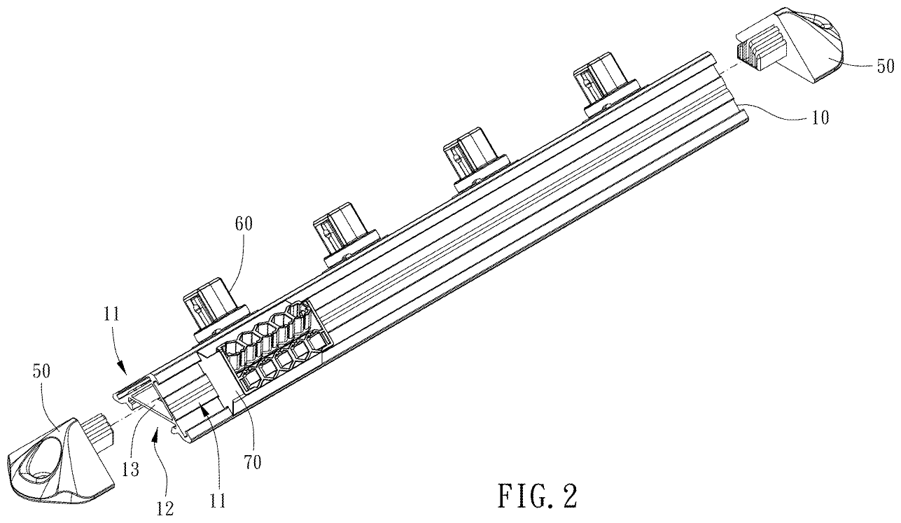

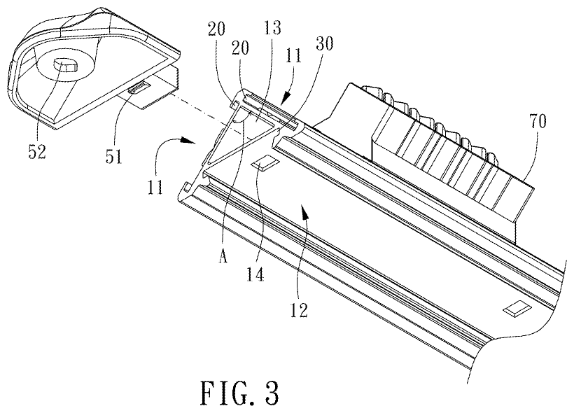

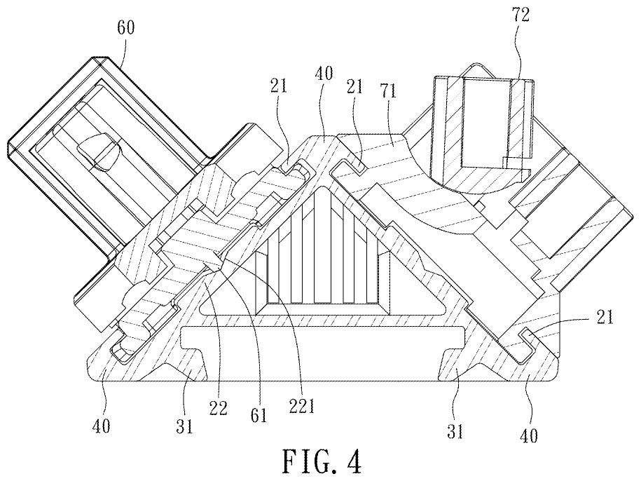

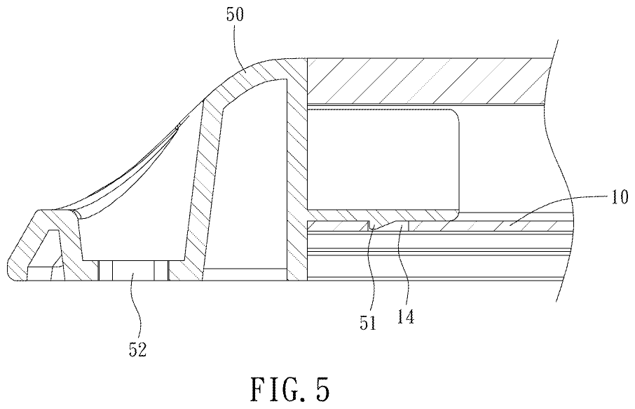

Please refer to FIGS. 1 to 5 for an exemplary embodiment of the present invention. A tool holder rail 1 of the present invention includes an elongate main body 10 and two rail slots 20.

The elongate main body 10 extends in a longitudinal direction L and includes two mounting sides 11 extending in the longitudinal direction L. The two mounting sides 11 are inclined to each other with an included angle A therebetween. The included angle A ranges from 45.0 to 150.0 degrees (such as 90 degrees, 120 degrees or 135 degrees). The two rail slots 20 are disposed on the two mounting sides 11, respectively. Each of the two rail slots 20 includes two flanges 21 extending in the longitudinal direction L and toward each other. Each of the two rail slots 20 is configured for slidable engagement of a tool seat. As such, it is capable of storing more tools and has a small volume with a single one a tool holder including the tool holder rail 1.

Preferably, the elongate main body 10 is integrally formed of one piece, and preferably made of metal such as aluminum, aluminum alloy or the like. The two flanges 21 of each of the two rail slots 20 are parallel to the longitudinal direction L and the two mounting sides 11, which is conducive to smooth movement of the tool seat.

In this embodiment, the tool holder rail 1 further includes an attachment slot 30 disposed on an attachment side 12 of the elongate main body 10, and the two mounting sides 11 and the attachment side 12 are connected to one another so that the elongate main body 10 is of a triangle configuration. The attachment slot 30 includes two flanges extending in the longitudinal direction L, extending toward each other, and extending in a direction perpendicular the longitudinal direction L. Each of the two flanges 31 of the attachment slot 30 is thicker than each said flange of each said mounting side 11, which provides large structural strength.

The tool holder rail 1 further includes corner portions 40, a first one of the corner portions 40 is integrally connected to and between two said flanges 21 of the two rail slots 20, a second one of the corner portions 40 is integrally connected to and between one of the two flanges 21 of one of the two rail slots 20 and one of the two flanges 31 of the attachment slot 30, a third one of the corner portions 40 is integrally connected to and between one of the two flanges 21 of the other of the two rail slots 20 and the other of the two flanges 31 of the attachment slot 30, and the two flanges 31 of the attachment slot 30 are flush with two of the corner portions 40 at the attachment side 12. Specifically, each of the two flanges 31 of the attachment slot 30 and one of the corner portions 40 form a toothed groove therebetween. As such, the tool holder rail 1 has a strong structure and can be attached to a mounting surface stably.

In this embodiment, a bottom of at least one of the two rail slots 20 includes an elongate projection 22 extending in the longitudinal direction L and wider than the two flanges 21 of each of the two rail slots 20. The elongate projection 22 reinforces the structural strength of the configuration of the rail slot. Specifically, the elongate projection 22 includes an elongate toothed groove 221. Preferably, the elongate main body 10 further includes two end openings 13, and two caps 50 are preferably inserted in the two end openings 13 and close the two end openings 13, respectively. Specifically, the elongate main body 10 further includes engaging holes 14, each of the two caps 50 includes a snap bump 51 which is releasably engaged in one of the engaging holes 14, and each of the two caps 50 further includes a through hole 52 for a fastener to disposed therethrough so that the tool holder rail 1 can be stably secured.

The present invention further provides a tool holder 100. The tool holder 100 includes the aforementioned tool holder rail 1 and a tool seat 60, 70 slidably engaged within one of the two rail slots 20, wherein the tool seat 60, 70 is configured for mounting of a tool such as a tool bit, socket or the like. The tool seat 60 may include a rib 61 projecting to be within the elongate toothed groove 221. Alternatively, the tool seat 70 may include a base 71 and a tool connector 72, the base 71 is slidably engaged within one of the two rail slots 20, and the tool connector 72 is rotatably connected to the base 71 and configured for mounting of a tool such as a tool bit.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool holder rail including:
an elongate main body extending in a longitudinal direction and including two mounting sides extending in the longitudinal direction, the two mounting sides being inclined to each other with an included angle therebetween; and
two rail slots disposed on the two mounting sides, respectively, each of the two rail slots including two flanges extending in the longitudinal direction and toward each other, each of the two rail slots being configured for slidable engagement of a tool seat.

2. The tool holder rail of claim 1, wherein the included angle ranges from 45.0 to 150.0 degrees.

3. The tool holder rail of claim 1, wherein the two flanges of each of the two rail slots are parallel to the longitudinal direction and the two mounting sides.

4. The tool holder rail of claim 3, further including an attachment slot disposed on an attachment side of the elongate main body, wherein the two mounting sides and the attachment side are connected to one another so that the elongate main body is of a triangle configuration.

5. The tool holder rail of claim 4, wherein the attachment slot includes two flanges extending in the longitudinal direction, extending toward each other, and extending in a direction perpendicular the longitudinal direction.

6. The tool holder rail of claim 5, further including corner portions, wherein a first one of the corner portions is integrally connected to and between the flanges of the two rail slots, a second one of the corner portions is integrally connected to and between one of the two flanges of one of the two rail slots and one of the two flanges of the attachment slot, a third one of the corner portions is integrally connected to and between one of the two flanges of the other of the two rail slots and the other of the two flanges of the attachment slot, and the two flanges of the attachment slot are flush with two of the corner portions at the attachment side.

7. The tool holder rail of claim 6, wherein each of the two flanges of the attachment slot and one of the corner portions form a toothed groove therebetween.

8. The tool holder rail of claim 1, wherein a bottom of at least one of the two rail slots includes an elongate projection extending in the longitudinal direction and wider than the two flanges of each of the two rail slots.

9. The tool holder rail of claim 8, wherein the elongate projection includes an elongate toothed groove.

10. The tool holder rail of claim 1, wherein the elongate main body further includes two end openings, and two caps are inserted in the two end openings and close the two end openings, respectively.

11. The tool holder rail of claim 10, wherein the elongate main body further includes engaging holes, and each of the two caps includes a snap bump which is releasably engaged in one of the engaging holes.

12. The tool holder rail of claim 10, wherein each of the two caps includes a through hole for a fastener to disposed therethrough.

13. A tool holder including the tool holder rail of claim 1 and a tool seat slidably engaged within one of the two rail slots.

14. The tool holder of claim 13, wherein a bottom of at least one of the two rail slots includes an elongate projection extending in the longitudinal direction, the elongate projection includes an elongate toothed groove, and the tool seat includes a rib projecting to be within the elongate toothed groove.

15. The tool holder of claim 13, wherein the tool seat includes a base and a tool connector, the base is slidably engaged within one of the two rail slots, and the tool connector is rotatably connected to the base and configured for mounting of a tool.
